(19) United States
(12) Patent Application Publication
(10) Pub. No.: US 2002/0074774 A1
(43) Pub. Date: Jun. 20, 2002

(54) Adjustable handle of umbrella stroller by telescoping and swiveling

(76) Inventors: Davin Hsu, Hsin Chu County (TW); Chih-ching Cheng, Hsin Chu County (TW)

Correspondence Address: Birch, Stewart, Kolasch & Birch, LLP, P.O. Box 747, Falls Church, VA, 22040-0747, US

(21) Appl. No.: 09/735,648

(22) Filed: Dec. 14, 2000

(51) Int. Cl. B62B 9/20

(52) U.S. Cl. 280/655.1

(57) ABSTRACT

An adjustable handle of the umbrella stroller by telescoping and swiveling. The handle of the invention includes a polygonal tube, a circular tube, a pulling sleeve, a spring piece, a grip fixed at the end of the circular tube, and a rotationally positioning spring piece. The polygonal tube with one end fixed to the frame of the umbrella stroller and provided with a plurality of positioning holes at each side of the polygonal tube. The circular tube is slidably installed into the other end of the polygonal tube and provided with a positioning hole, at least one rotationally positioning hole, and a slot at the wall of the circular tube. The pulling sleeve is combined with the circular tube by a knob passing through the wall of the pulling sleeve and the slot such that the pulling sleeve is moved along the circular tube in the range defined by the length of the slot. With one end fixed at the inside of the circular tube and another end fixed at the knob, the spring piece is provided with a protruding portion which is protruded from the positioning hole of the circular tube and one of the positioning holes of the polygonal tube such that the circular tube is positioned after the circular tube is displaced with respect to the polygonal tube. The rotationally positioning spring piece is disposed at the far end of the circular tube relative to the grip and provided with two protruding portions that are protruded from the rotationally positioning holes respectively for positioning the circular tube as the circular tube revolves with respect to the polygonal tube.

### BACKGROUND OF THE INVENTION

1. Field of the Invention

The present invention relates to a handle of the umbrella stroller, particularly to an adjustable handle of umbrella stroller by telescoping and swiveling.

2. Description of the Related Art

A conventional baby stroller is usually disposed with the handles at the rear side. It is inconvenient for the parents to watch over the baby in the stroller since the baby generally sits facing away from them. The parents then have to stop for the baby's temperament from time to time. To improve this situation, the handle of the baby stroller should be more flexible for handling in such a way that the parents can easily control the baby stroller by adjusting the angle and the length of the handle. Therefore, the parents can watch over the baby conveniently and drive the stroller more safely on different terrain by adjusting the stroller's handle.

### SUMMARY OF THE INVENTION

One of the objects of the invention is to provide a pair of adjustable handles of the umbrella stroller by telescoping and swiveling. Each handle of the invention includes a polygonal tube, a circular tube, a pulling sleeve, a spring piece, a grip fixed at the end of the circular tube, and a rotationally positioning spring piece. The polygonal tube with one end fixed to the frame of the baby stroller is formed with a plurality of positioning holes at each side of the polygonal tube while the circular tube is slidably installed into the other end of the polygonal tube. The circular tube is provided with a positioning hole, at least a rotationally positioning hole, and a through hole at the wall of the circular tube. The pulling sleeve is combined with the circular tube by a knob passing through the side of the pulling sleeve and the through hole such that the pulling sleeve is moved along the circular tube in the range defined by the length of the through hole. The spring piece, with one end fixed inside the circular tube and another end fixed at the knob, is provided with a protruding portion which is protruded from the positioning hole of the circular tube and one of the positioning holes of the polygonal tube such that the circular tube is positioned after the circular tube is displaced with respect to the polygonal tube. The rotationally positioning spring piece is disposed at the far end of the circular tube relative to the grip and is provided with at least one protruding portion that is protruded from one of the rotationally positioning holes for positioning the circular tube as the circular tube revolves with respect to the polygonal tube.

### BRIEF DESCRIPTION OF THE DRAWINGS

These and other objects and advantages of the present invention will become apparent by referring to the following description and accompanying drawings wherein:

FIG. 1 is a pictorial view illustrating the baby stroller according to the embodiment of the invention.

FIG. 2 is a cross-sectional view illustrating assembly of the square tube and circular tube according to the embodiment of the invention.

FIG. 3A is a side view of the circular tube according to the embodiment of the invention.

FIG. 3B is another side view of the circular tube according to the embodiment of the invention.

FIG. 4 is a side view of the square tube according to the embodiment of the invention.

FIG. 5 is a top view of the spring piece according to the embodiment of the invention.

FIG. 6 is a side view of the spring piece according to the embodiment of the invention.

FIG. 7A is a side view of the rotationally positioning spring piece according to the embodiment of the invention.

FIG. 7B is a top view of the rotationally positioning spring piece according to the embodiment of the invention.

FIG. 7C is a cross-sectional view of the rotationally positioning spring piece arranged inside the circular tube according to the embodiment of the invention.

### DETAIL DESCRIPTION OF THE INVENTION

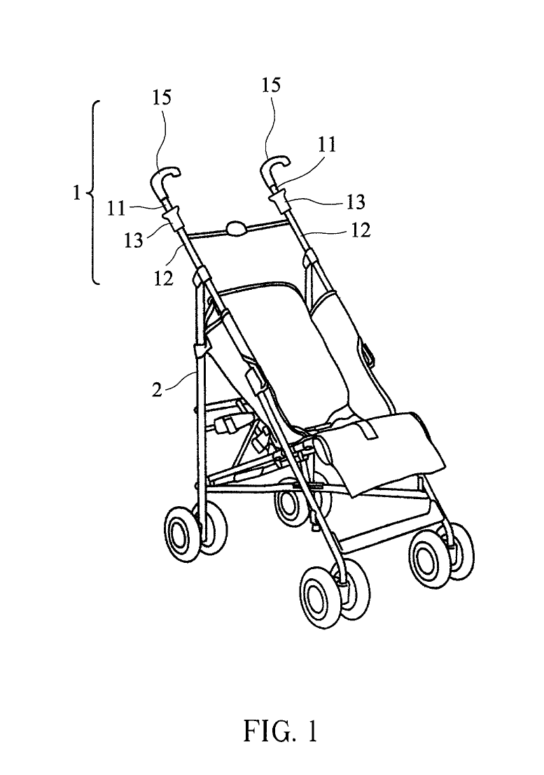

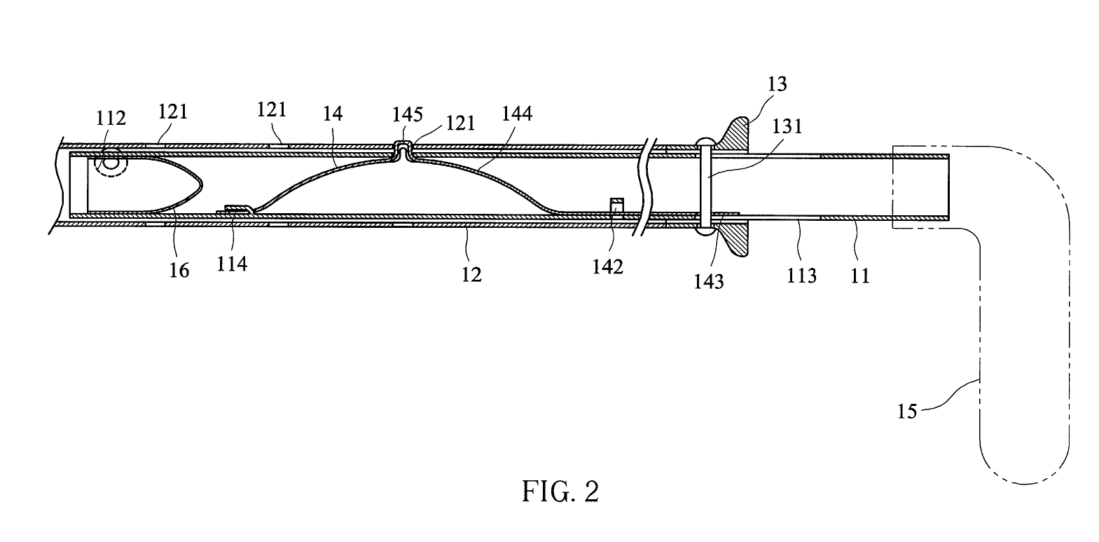

According to one of the embodiments of the invention, an adjustable handle 1 of the umbrella stroller by telescoping and swiveling includes a square tube 11, a circular tube 12, a pulling sleeve 13, a spring piece 14, a grip 15 fixed one end of the circular tube 12, and an rotationally positioning spring piece 16, as shown in FIGS. 1 and 2.

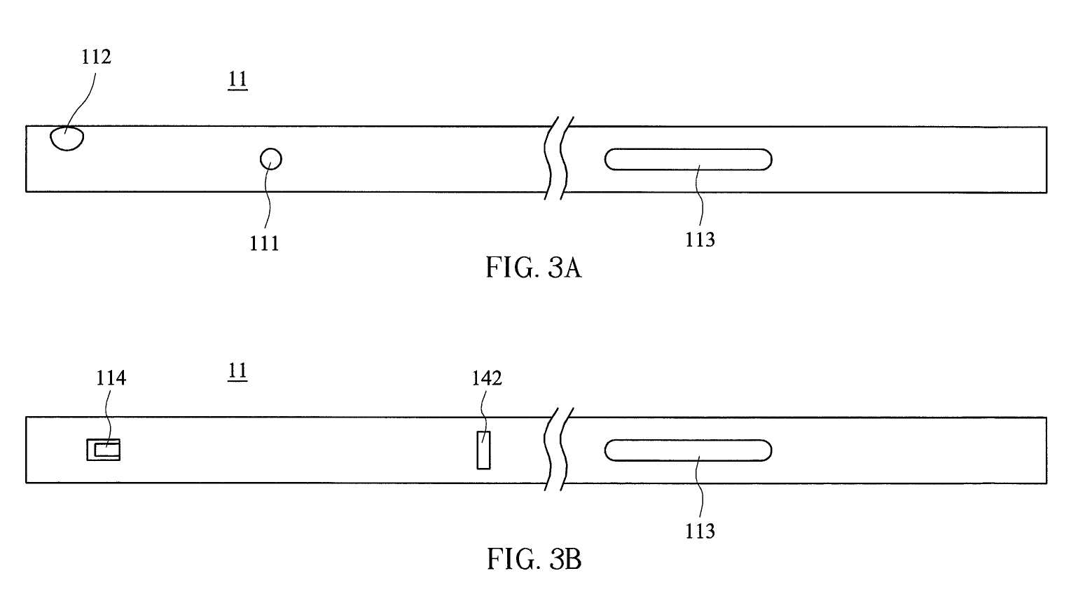

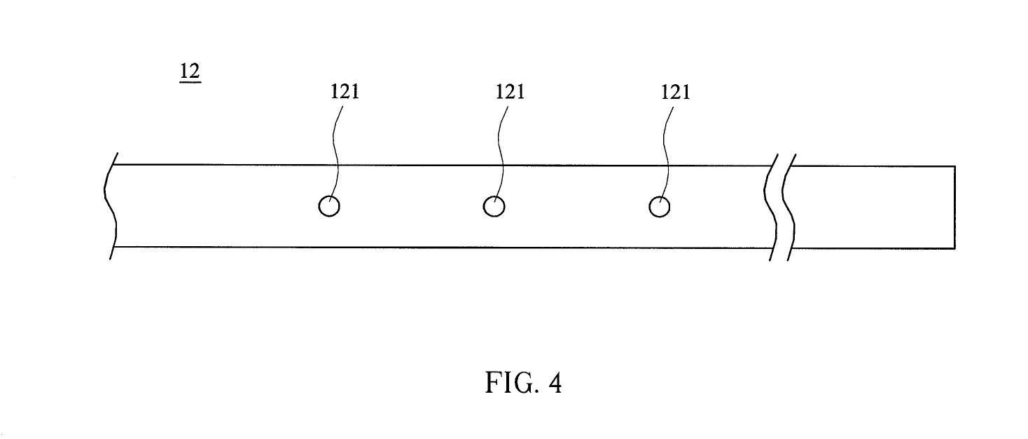

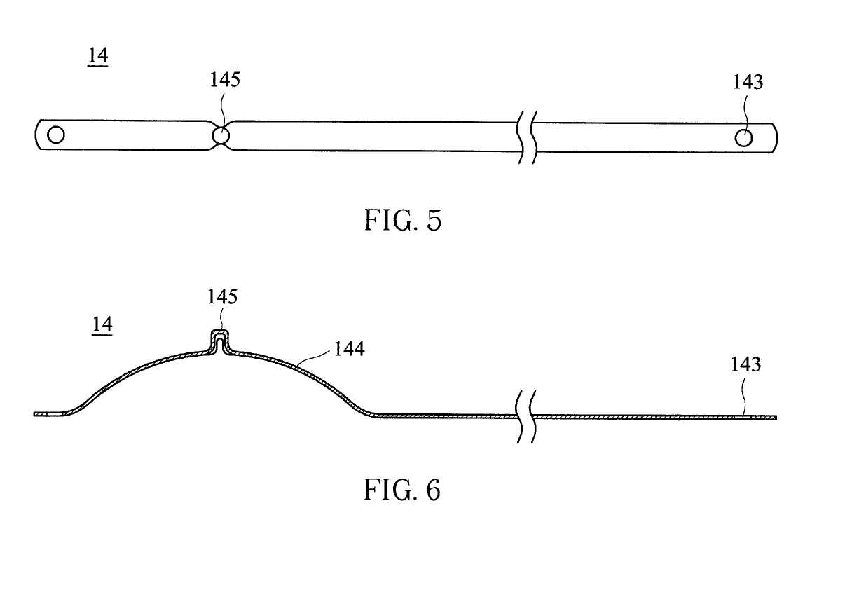

Referring to FIG. 1 and 4, one end of the square tube 12 is fixed to the frame 2 of the baby stroller, and the each side of the square tube 12 is provided with a plurality of positioning holes 121. As shown in FIG. 3A and 3B, the side of the circular tube 11 with one end slipped into the square tube 11 is provided with a positioning hole 111, two rotationally positioning holes 112, and a slot 113. As shown in FIG. 2, the pulling sleeve 13 is combined with the circular tube 11 by a knob 131 passing through the side of the pulling sleeve 13 and the slot 113 such that the pulling sleeve 13 is moved along the circular tube 11 in the range defined by the length of the slot 113 as the user of the baby stroller controls the handle 1.

The spring piece 14 has one end fixed at a fixing portion 114 and another end 143 fixed at the knob 131 by passing through a punched hole 142 inside the circular tube 11. The arc portion 144 of the spring piece 14 is formed with a protruding portion 145 that is able to protrude from the positioning hole 111 and one of the positioning holes 121. As the user of the baby stroller controls the handle 1 by holding the grip 15 and lifting the pulling sleeve 13 along the circular tube 11, the spring piece 14 is as well extended such that the protruding portion 145 is separated from the positioning hole 111. With respect to the square tube 12, the circular tube 11 is further displaced upward to a certain position by lifting the grip 15. At this time, the user releases the pulling sleeve 14 so that the spring piece 14 can spring back until the protruding portion 145 is protruded from another positioning holes 121 again. Since the punched hole 142 serves to secure the spring piece 14, the arc portion 144 with the protruding portion 145 can still maintain its arc shape such that the protruding portion 145 can protrude into another positioned hole as the spring piece 14 springs back. Up to now, a telescoping process of the handle 1 is thus completed.

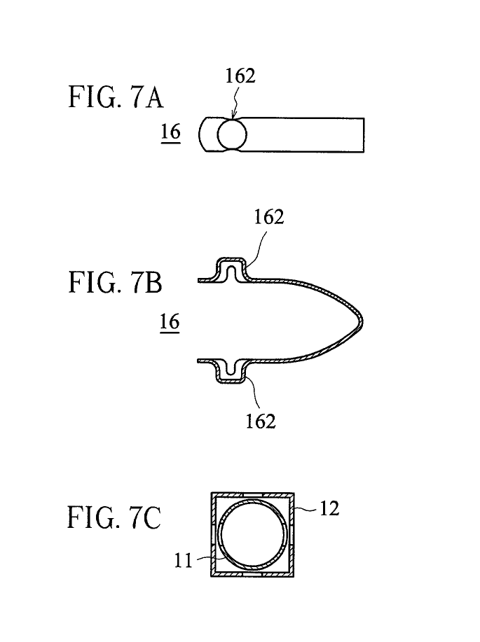

As shown in FIG. 7A, 7B, and 7C, the rotationally positioning spring piece 16 is formed with two protruding portions 162 and is installed at the far end of circular tube 11 relative to the grip 15 in a cross-sectional way wherein two protruding portions 162 are protruded from two rotationally positioning holes 112 respectively. When the user holds the grip 15 and lifts up the pulling sleeve 13 as to separate the protruding portion 145 from the positioning hole 111, the circular tube is then free to be turned inside the square tube 12 wherein the protruding portions 162 serves to position the revolving circular tube 11 by protruding from different rotationally positioning holes at the four sides of the square tube 12. Normally, each protruding portion 162 is confined in a corner 123 of the square tube 12. As the circular tube 11 is turned a roughly 45 degrees angle, the inner wall of the square tube 12 then presses the protruding portion 162 such that the circular tube 11 is free to be turned continuously. Continuing another 45 degrees turning, the circular tube 11 is confined in another corner 123 of the square tube 12, thus a swiveling process of the handle 1 is completed.

It should be noted that the square tube 12 could be adapted into different polygonal shapes in order to perform a finer angle adjustment and improve the agility of the handle 1.

While this invention has been described with reference to an illustrative embodiment, it is not intended that this description be construed in a limiting sense. Various modifications and combinations of the illustrative embodiment, as well as other embodiments of the invention, will be apparent to persons skilled in the art upon reference to the description. It is therefore intended that the appended claims encompass any such modifications or embodiments.

What is claimed is:

1. An adjustable handle of the umbrella stroller by telescoping and swiveling, comprising:
a polygonal tube with one end fixed to the frame of the umbrella stroller and provided with a plurality of positioning holes at each side of said polygonal tube;
a circular tube slidably installed into the other end of said polygonal tube and provided with a positioning hole, at least one rotationally positioning hole, and a through hole at the wall of said circular tube;
a pulling sleeve combined with said circular tube by a knob passing through the wall of said pulling sleeve and said slot such that said pulling sleeve is moved along said circular tube in the range defined by the length of said slot;
a spring piece with one end fixed to the inside of said circular tube and another end fixed at said knob, said spring piece being provided with a protruding portion which is protruded from said positioning hole of said circular tube and one of said positioning holes of said polygonal tube such that said circular tube is positioned after said circular tube is displaced with respect to said polygonal tube;
a grip fixed at one end of said circular tube; and
a rotationally positioning spring piece disposed at the far end of said circular tube relative to said grip and provided with at least one protruding portion which is protruded from one of said rotationally positioning holes for positioning said circular tube as said circular tube revolves with respect to said polygonal tube.

2. The adjustable handle of the umbrella stroller by telescoping and swiveling as claimed in claim 1, wherein said polygonal tube is a square tube.
